(19) United States
(12) Patent Application Publication
(10) Pub. No.: US 2012/0093556 A1
(43) Pub. Date: Apr. 19, 2012

(54) KEYBOARD KEY OF INPUT DEVICE

(75) Inventors: GUO-YI CHEN, Shenzhen City (CN); HAI-QING ZHOU, Shenzhen (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/912,778

(22) Filed: Oct. 27, 2010

(30) Foreign Application Priority Data
Oct. 19, 2010 (CN) 201010511552.0

(51) Int. Cl. B41J 5/00

(52) U.S. Cl. 400/494

(57) ABSTRACT

A key includes a frame with a top, a fluorescent layer coated on the top, and a symbol protruding up from the fluorescent layer.

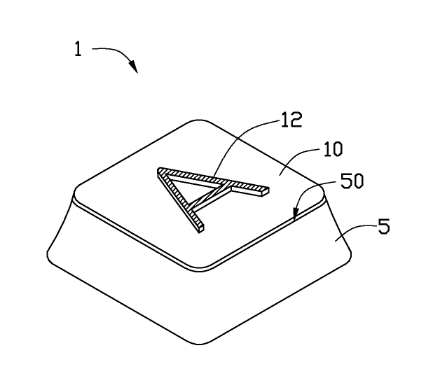

### BACKGROUND

1. Technical Field

The present disclosure relates to a key of a keyboard input device.

2. Description of Related Art

Keyboards are widely used now, but the keys on the keyboards generally cannot be seen clearly in the dark, which is inconvenient.

### BRIEF DESCRIPTION OF THE DRAWING

Many aspects of the present embodiments can be better understood with reference to the following drawing. The components in the drawing are not necessarily drawn to scale, the emphasis instead being placed upon clearly illustrating the principles of the present embodiments. Moreover, in the drawing, the view is schematic.

The FIGURE is an isometric view of an exemplary embodiment of a key of a keyboard input device.

### DETAILED DESCRIPTION

The disclosure, including the accompanying drawing, is illustrated by way of example and not by way of limitation. It should be noted that references to “an” or “one” embodiment in this disclosure are not necessarily to the same embodiment, and such references mean at least one.

Referring to the FIGURE, an exemplary embodiment of a key 1 of a keyboard includes a hollow trapezoid-shaped frame 5, a fluorescent layer 10, and a symbol 12. The frame 5 includes a top 50. The fluorescent layer 10 is coated on the top 50. The symbol 12 protrudes up from the fluorescent layer 10. In other embodiments, the symbol 12 protrudes up from corresponding parts of the top 50, and other parts of the top 50 are coated with the fluorescent layer 10. In this embodiment, the fluorescent layer 10 is a light color such as white, and the symbol 12 is a dark color such as black, so that contrast is high and the symbol 12 may be clearly seen in the dark. Furthermore, the protrudent symbol 12 is convenient for sight-impaired users to discern by touch.

It is believed that the present embodiments and their advantages will be understood from the foregoing description, and they will be apparent that various changes may be made thereto without departing from the spirit and scope of the description or sacrificing all of their material advantages, the examples hereinbefore described merely being exemplary embodiment.

What is claimed is:

1. A key comprising:
a frame comprising a top;
a fluorescent layer coated on the top of the frame; and
a symbol protruding up from the fluorescent layer.

2. The key of claim 1, wherein the fluorescent layer is a light color, the symbol is a dark color.

3. The key of claim 2, wherein the fluorescent layer is white, the symbol is black.

4. A key comprising:
a frame comprising a top;
a symbol protruding up from the top; and
a fluorescent layer coated on other parts of the top.

5. The key of claim 4, wherein the fluorescent layer is a light color, the symbol is a dark color.

6. The key of claim 5, wherein the fluorescent layer is white, and the symbol is black.

7. A key comprising:
a fluorescent top; and
a non-fluorescent symbol protruding up from the top.

8. The key of claim 7, wherein the fluorescent top is a fluorescent layer.

9. The key of claim 8, wherein fluorescent layer is light-colored, the symbol is dark-colored.

10. The key of claim 9, wherein the fluorescent layer is white, the symbol is black.

11. The key of claim 8, wherein the non-fluorescent symbol protrudes from the fluorescent layer.

12. The key of claim 8, wherein the fluorescent layer is only formed where the non-fluorescent symbol does not protrude.
